(19) United States
(12) Patent Application Publication
(10) Pub. No.: US 2010/0149731 A1
(43) Pub. Date: Jun. 17, 2010

(54) ELECTRICAL PANEL

(76) Inventor: Michael Blair Hopper, Worcester, MA (US)

Correspondence Address: Richard L. Sampson;SAMPSON & ASSOCIATES, P.C., 50 Congress Street, Boston, MA, 02109, US

(21) Appl. No.: 12/630,074

(22) Filed: Dec. 3, 2009

Related U.S. Application Data
(60) Provisional application No. 61/121,816, filed on Dec. 11, 2008.
(60) Provisional application No. 61/121,810, filed on Dec. 11, 2008.

(51) Int. Cl. H02B 1/015

(52) U.S. Cl. 361/627

(57) ABSTRACT

An AC/DC electrical distribution panel includes a housing, a line voltage alternating current (AC) port configured for connection to an electrical distribution grid at line voltage, and a low voltage direct current (DC) port configured for connection to a DC load. A circuit board assembly is electrically coupled to the AC port and the DC port, and includes an AC connector array coupled to the AC port, and a DC connector array coupled to the DC port. One or more modular AC/DC power supplies are removably coupled to the AC and DC connector arrays. A processor is operatively engaged with the circuit board assembly, and configured to selectively switch the power supplies on and off. The circuit board assembly includes a current meter configured to monitor the current load being drawn from the DC port, wherein the processor is configured to selectively activate and deactivate various power supplies in response to the monitored current load.

### RELATED APPLICATION

This application claims the benefit of U.S. Provisional Patent Applications Ser. Nos. 61/121,816, entitled AC/DC Electrical Panel, filed on Dec. 11, 2008, and 61/121,810, entitled Energy Efficient Lighting System and Method, filed on Dec. 11, 2008, the contents of which are incorporated herein by reference in their entireties for all purposes.

This application is also related to U.S. patent application Ser. No. ______, entitled Energy Efficient Lighting System and Method, filed on even date herewith, and referenced by Attorney Docket No. 1185006, the contents of which are incorporated herein by reference in their entirety for all purposes.

### BACKGROUND

1. Technical Field

This invention relates to energy efficient lighting and light management systems, devices and methods. More particularly, the present invention relates to energy efficient low voltage power distribution and management systems, devices, and methods.

2. Background Information

Throughout this application, various publications, patents and published patent applications are referred to by an identifying citation. The disclosures of the publications, patents and published patent applications referenced in this application are hereby incorporated by reference into the present disclosure.

There is a continual push to reduce energy consumption, because of rising energy costs and negative environmental impacts of energy usage and energy generation. This push has generated interest in new technologies which not only operate more efficiently, but which also may be operated at partial-power without harm to the devices, such as during times of particularly heavy energy demand.

The foregoing requirements have been a driving force behind the development of low power lighting systems. One approach, for example, has been to replace incandescent lights with more energy efficient fluorescent lights. Fluorescent lights generate substantially less heat than incandescent bulbs, and thus use far less electricity for a given amount of light output. However, most fluorescent lights are not easily dimmed, which militates against partial power operation.

Another approach has been to develop lighting systems that take advantage of the low power requirements of light emitting diodes (LEDs). LEDs operate with DC current, which enables them to be easily dimmed, e.g., by simply reducing the DC voltage. Most currently available LED lights have been developed to replace conventional line voltage (e.g., 110 or 220 VAC) incandescent bulbs. These lights, however, tend to be relatively expensive and have relatively short useful lives due to failure of the components associated with them (e.g., transformers/rectifiers fabricated to small size and packaged into each bulb in order to convert AC line voltage to the low voltage DC power typically required by the LEDs. Failure of these lights may also present electrical shock and fire hazards, due to their use of line voltage.

Many other devices also rely on DC, rather than AC, power. Indeed, most of today's consumer electronics, including laptop computers, cell phones, mp3 music players, and handheld electronic games are powered by rechargeable batteries. These devices are recharged by power supplies that convert conventional alternating current (AC) line voltage to the DC power required to operate the devices and/or recharge the batteries. Consumers typically have a large number of such power supplies, many of which remain plugged into power outlets where they consume “vampire” power even when not being used to operate or charge their associated devices.

Therefore, there is a need for a system and method for efficient power delivery to low voltage, low power devices to facilitate energy conservation.

### SUMMARY

In one aspect of the invention, an AC/DC electrical distribution panel includes a housing, a line voltage alternating current (AC) port configured for connection to an electrical distribution grid at line voltage, and a low voltage direct current (DC) port configured for connection to a DC load. A circuit board assembly is electrically coupled to the AC port and the DC port, and includes an AC connector array coupled to the AC port, and a DC connector array coupled to the DC port. One or more modular AC/DC power supplies are removably coupled to the AC and DC connector arrays. A processor is operatively engaged with the circuit board assembly, and configured to selectively switch the power supplies on and off. The circuit board assembly includes a current meter configured to monitor the current load being drawn from the DC port, wherein the processor is configured to selectively activate and deactivate various power supplies in response to the monitored current load.

In another aspect of the invention, the foregoing aspect may be modified to also include one or more modular NEC Class 2 AC/DC power supplies removably coupled to the AC and DC connector arrays. In addition, an IP communication module is coupled to the processor, wherein the processor is configured to reduce DC power outputted by the panel in response to communications received by the communications module. The communications module is also configured to communicate with networked devices coupled to the DC port. The processor is configured to deactivate individual ones of the power supplies and generate an alarm signal upon detection of power output outside of a predetermined range. DC power contacts are coupled to the DC connector array, and are configured to receive DC power from local sources. The processor is configured to turn off the power supplies as power from local power sources are available. One or more DC to AC inverters configured to generate AC power when sufficient local power sources are available.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a front elevational view of an embodiment of the present invention; and

FIG. 2 is a perspective front view of the embodiment of FIG. 1.

### DETAILED DESCRIPTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. In addition, well-known structures, circuits and techniques have not been shown in detail in order not to obscure the understanding of this description. The following detailed description is, therefore, not to be taken in a limiting sense, and the scope of the present invention is defined by the appended claims and their equivalents. For clarity of exposition, like features shown in the accompanying drawings are indicated with like reference numerals and similar features as shown in alternate embodiments in the drawings are indicated with similar reference numerals.

Where used in this disclosure, the terms “computer” and “network element” are meant to encompass a workstation, personal computer, personal digital assistant (PDA), wireless telephone, or any other suitable computing device including a processor, a computer readable medium upon which computer readable program code (including instructions and/or data) may be disposed, and a user interface. The terms “real-time” and “on-demand” refer to sensing and responding to external events nearly simultaneously (e.g., within milliseconds or microseconds) with their occurrence, or without intentional delay, given the processing limitations of the system and the time required to accurately respond to the inputs.

The system and method embodying the present invention can be programmed in any suitable language and technology, such as, but not limited to: C++; Visual Basic; Java; VBScript; Jscript; BCMAscript; DHTM1; XML and CGI. Alternative versions may be developed using other programming languages including, Hypertext Markup Language (HTML), Active ServerPages (ASP) and Javascript. Any suitable database technology can be employed, such as, but not limited to, Microsoft SQL Server or IBM AS 400.

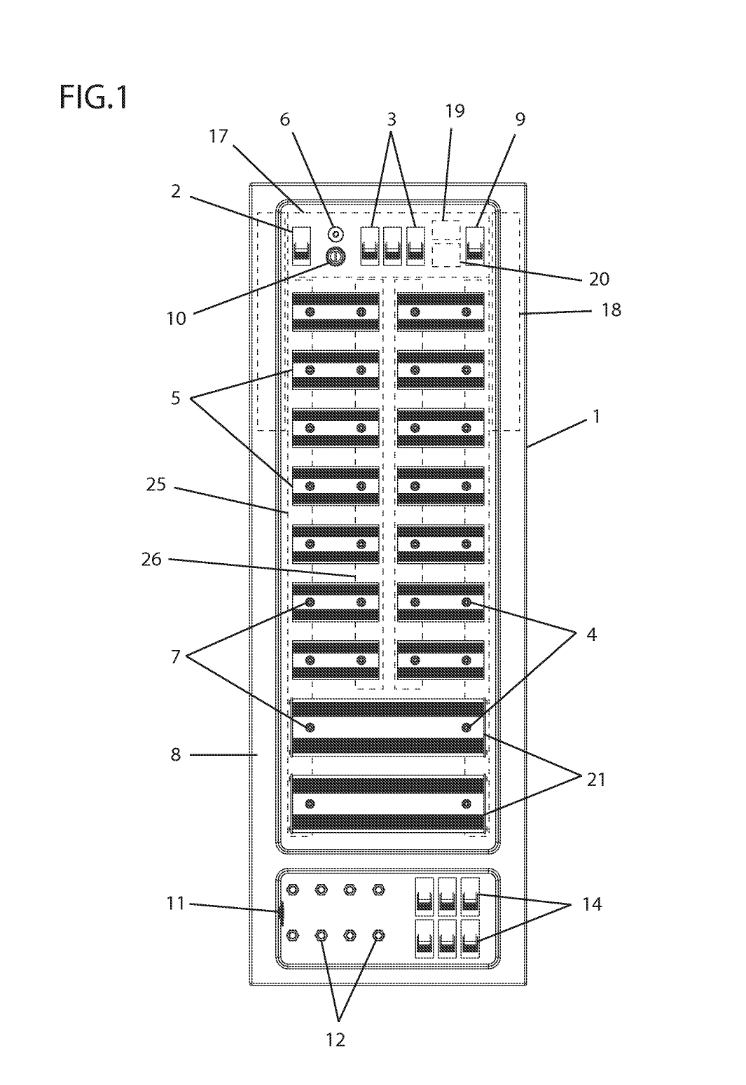

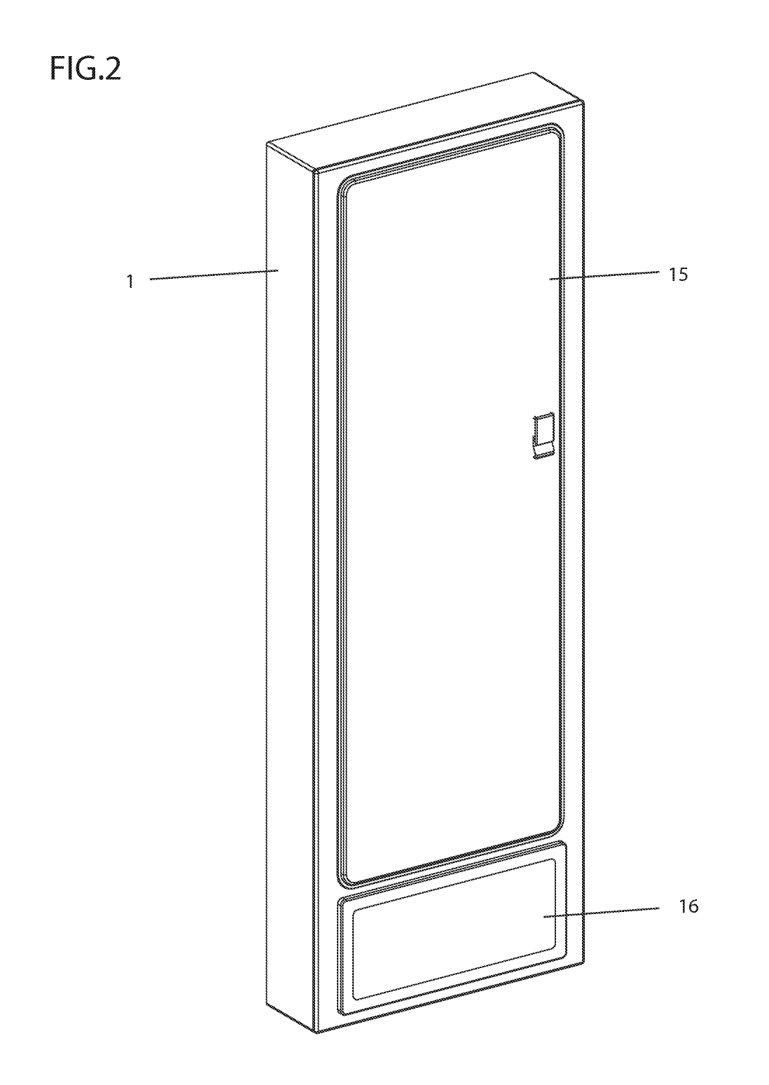

Briefly, as shown in FIGS. 1 and 2, an exemplary embodiment of the present invention includes an electrical panel 1 configured to convert AC line voltage (e.g., 110 or 220 VAC) to DC power (which in particular embodiments is relatively low voltage, e.g., 12 or 24 VDC) in residential and/or commercial premises. This DC power may then be fed to low voltage wiring at the premises for direct use by various devices and household appliances, including LED lighting installed within the premises.

These embodiments thus provide for centralized, efficient transformation of AC to DC power to substantially eliminate the need for separate power supplies at each of the various individual devices to convert line voltage to DC power. This centralization offers various benefits, ranging from energy efficiency to resource conservation and fire safety.

For example, conventional line voltage wiring for lights, outlets, etc., may be replaced with smaller gauge low voltage wiring, for substantial reduction in copper/aluminum. Moreover, particular embodiments provide the AC to DC conversion using NEC (National Electrical Code) Class 2 power supplies. The NEC recognizes Class 2 power supplies as being safe from a fire initiation and electric shock standpoint due to their relatively low power, current and voltage characteristics. As such, these embodiments provide substantial fire safety improvements relative to conventional line voltage wiring.

Still further, the centralized DC conversion of the present invention facilitates various advanced energy conservation measures, such as on-demand load reduction. For example, embodiments of panel 1 include a communication module 10 which a utility or other third party may access to reduce power outputted by panel 1, e.g., to LED lighting, during times of peak demand or “brown out” conditions. LED lights, in contrast to most fluorescent lights, are easily dimmed, making these embodiments particularly well suited to such demand-side management programs, in which energy consumers volunteer to have their energy consumption automatically curtailed in times of high energy demand. (Reductions in electrical billing rates may be offered as incentives for consumers to opt in to such demand-side management programs.). These approaches may thus not only reduce individual consumers' energy usage, but may also substantially reduce or eliminate the need for utility companies to construct new power generation facilities to handle peak demand. Once activated by the user, e.g., with a key or code, module 10 enables the processor 19 to communicate with the utility/third party by signals sent to it via the AC power lines of the national grid, and/or via other wired or wireless communications, such as via an IP network.

In particular embodiments, module 10 may be configured as an IP network (and/or MAC address) module that is communicably coupled to processor 19 to enable communication via an IP network. Module 10 may also be used to communicate to networked devices such as light systems, appliances, and other “smart” devices powered by panel 1 and which are equipped with their own IP modules. In such an application, the low voltage wiring supplying power from panel 1 to the networked devices may also be used for communication. Moreover, rather than simply lowering power supplied to them, panel 1 may simply transmit a communication to these smart devices instructing them to reduce their power usage.

Described now in greater detail, referring to FIG. 1, electrical panel 1 includes a front panel 8 that may be removed to expose internal circuitry and wiring in a manner similar to that of conventional electrical circuit breaker panels and load centers. As with such conventional electrical panels, line voltage is fed into panel 1 and connected to an AC port which may include a main AC circuit breaker 2. A conventional 30 amp circuit breaker may be sufficient for most applications, although circuit breakers of substantially any desired capacity may be used without departing from t he scope of the present invention.

The output side of the circuit breaker 2 is connected to a circuit board assembly 17 (shown in phantom). The circuit board assembly 17 switchably connects the circuit breaker 2, e.g., via modular connectors disposed on an AC connector array 25, (shown in phantom) to the AC sides of each of a series of modular power supplies 5. This switchable connection to each of the power supplies 5 enables each power supply to be selectively activated and deactivated as needed, such as by a processor 19 (shown in phantom) communicably coupled to the circuit board/switches. The DC sides of the power supplies 5 are electrically connected, e.g., via modular connectors on a low voltage DC connector array 26 (shown in phantom), to a DC terminal strip 18 (shown in phantom). (It should be recognized that in particular embodiments, this connection of the power supplies 5 to DC connector array 26 may also be switchable, e.g., to permit the power supplies 5 to be electrically isolated from any DC power supplies as discussed hereinbelow.) Terminal strip 18 is configured in a conventional manner to permit electricians or other installers to connect low voltage wiring to distribute the DC side of the power supplies 5 throughout the premises to various low voltage loads, such as lights, devices, etc.

In addition to processor 19, circuit board 17 may also include a current meter 20 (shown in phantom) configured to monitor the current load being drawn from the terminal strip 18. As power requirements change, processor 19 may selectively activate and deactivate various power supplies 5 to optimize efficiency. In this regard, it should be recognized that conventional AC to DC power supplies are generally most efficient when operated at or near their full capacity. Processor 19 may thus be configured to selectively activate power supplies 5 as needed so that at any given time, no more than one power supply 5 is operating at sub-optimal efficiency. Processor 19 may also be configured to rotate the power supplies being used so as not to orphan some of them, i.e., to ensure that all the power supplies are used. The processor 19 may also limit the output to each terminal connection to less than a predetermined power level, e.g., 100 watts or less.

If processor 19 determines that a power supply has failed, e.g., upon detection of DC output above or below expected levels, the processor may deactivate the power supply 5 by switching off its connection to AC power as discussed above. In the event of a failure, processor 19 may activate any other unused power supplies 5 in order to meet the demand for power at the premises. In addition, processor 5 may alert occupants that a power supply has failed by actuating an alarm. For example, the processor 19 may repeatedly cycle power on and off so that lights, for example, will blink or dim to signal occupants that a power supply 5 needs to be replaced. This blinking will continue, e.g., every 2 to 5 minutes, until a user visits the panel 1 and depresses reset button 6 to clear the alarm/fault.

As also shown, each of the power supplies 5 (and inverters 21 as discussed hereinbelow) may be provided with a DC circuit breaker 4 configured to automatically shut down the power supply in the event of overload. The power supplies 5 (and inverters 21) may also include a monitoring indicator (e.g., LED) 7 which provides a visual indication of whether or not the power supplies are functioning properly. Thus, a user responding to the aforementioned alarm may determine which of the power supplies 5 has failed simply by viewing the indicators 7. In particular embodiments, the power supplies 5 are connected to connector arrays 25 and 26 by modular snap-type connectors, such as of the type commonly used to connect circuit breakers to bus bars of conventional electrical circuit breaker panes. Thus, the failed power supply 5 may be replaced in a modular fashion by simply unplugging it from the connector arrays 25, 26 and plugging in a new power supply 5.

Still further, in particular embodiments, panel 1 may include DC power contacts 12, which may be used to receive power from local sources such as solar and wind generators at the premises. These contacts 12 may be electrically coupled to the low voltage connector array 26 via DC circuit breakers 14. Contacts 12 may also serve as battery connections which may be used to store power provided by power supplies 5 and/or local sources for use in the event of a power outage. It should be recognized that the processor 19 may be programmed to use the local DC sources as the primary power source, when available, and to only use the AC feed when needed. The circuit board 17 also may include conventional voltage regulators associated with various DC contacts 12 to maintain the batteries at peak charge. Still further, processor 19 may be configured to track energy usage and maintain a log of power usage from the various sources. In this regard, processor 19 may be provided with an integral memory, such as a random access memory (RAM), to store this information for later retrieval. As also shown, panel 1 may include a manual override switch 9 that is actuatable to provide low voltage DC power even in the event of a failure of circuit board 17.

Moreover, DC to AC inverters 21, connected to arrays 25, 26 may be provided to effectively back-feed circuit breaker 2 with AC power from DC sources, e.g., to sell power back to the utility when local sources (e.g., solar, wind) are providing excess DC power. 25 The inverters 21 may also be configured to feed AC power to a series of AC circuit breakers 3. These circuit breakers 3 may be used to supply power to various conventional AC-powered devices such as gas or oil fired furnaces, well pumps, and refrigerators, etc.

A connector 11 may be provided for electrical connection to a touch screen/door 16 disposed to cover contacts 12, etc., as shown in FIG. 2. The touch screen may be used as a display to show a user the current state of the panel, for example, the amount of power being provided by any local DC sources, which power supplies are currently in use, programming, etc. As also shown, panel 1 may be provided with a door 15 to cover power supplies 5, etc.

It should be recognized that the aforementioned on-demand power reduction may be accomplished in any suitable manner. For example, power may be reduced by limiting the current and/or voltage output by power supplies 5, e.g., to dim LED lights being powered by panel 1. Alternatively, more sophisticated approaches such as Pulse Width Modulation (PWM) may be used for dimming, without departing from the scope of the present invention. Moreover, it should be recognized that provision may be made for reducing power to particular circuits (e.g., those powering LED lights), without reducing power to other circuits powering electrical loads that may be less tolerant of power fluctuations.

Those skilled in the art should recognize that the aforementioned switched connection of the power supplies to the AC port may be accomplished in substantially any convenient manner, such as by switches external or internal to the power supplies, and which may be actuated in response to signals generated by processor 19.

It should be noted that the various modules and other components of the embodiments discussed hereinabove may be configured as hardware, as computer readable code stored in any suitable computer usable medium, such as ROM, RAM, flash memory, phase-change memory, magnetic disks, etc., and/or as combinations thereof, without departing from the scope of the present invention.

It should be understood that any of the features described with respect to one of the embodiments described herein may be similarly applied to any of the other embodiments described herein without departing from the scope of the present invention.

In the preceding specification, the invention has been described with reference to specific exemplary embodiments for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

Having thus described the invention, what is claimed is:

1. An AC/DC electrical distribution panel comprising:
a housing;
a line voltage alternating current (AC) port configured for connection to a national electrical distribution grid at line voltage;
a low voltage direct current (DC) port configured for connection to a DC load;
a circuit board assembly electrically coupled to the AC port and the DC port;
the circuit board assembly including an AC connector array coupled to the AC port, and a DC connector array coupled to the DC port;
one or more modular NEC Class 2 AC/DC power supplies removably coupled to the AC connector array and the DC connector array;
a processor operatively engaged with the circuit board assembly, the processor configured to selectively switch the power supplies on and off;
the circuit board assembly including a current meter configured to monitor the current load being drawn from the DC port, wherein the processor is configured to selectively activate and deactivate various power supplies in response to the monitored current load;
an IP communication module coupled to the processor;
wherein the processor is configured to reduce DC power outputted by the panel in response to communications received by the communications module;
the communications module being configured to communicate with networked devices coupled to the DC port;
the processor is configured to deactivate individual ones of the power supplies and generate an alarm signal upon detection of power output outside of a predetermined range;
DC power contacts coupled to the DC connector array, the DC power contacts configured to receive DC power from local sources;
the processor configured to turn off the power supplies as power from local power sources are available; and
one or more DC to AC inverters configured to generate AC power when sufficient local power sources are available.

2. An AC/DC electrical distribution panel comprising:
a housing;
a line voltage alternating current (AC) port configured for connection to an electrical distribution grid at line voltage;
a low voltage direct current (DC) port configured for connection to a DC load;
a circuit board assembly electrically coupled to the AC port and the DC port;
the circuit board assembly including an AC connector array coupled to the AC port, and a DC connector array coupled to the DC port;
one or more modular AC/DC power supplies removably coupled to the AC connector array and the DC connector array;
a processor operatively engaged with the circuit board assembly, the processor configured to selectively switch the power supplies on and off; and
the circuit board assembly including a current meter configured to monitor the current load being drawn from the DC port, wherein the processor is configured to selectively activate and deactivate various power supplies in response to the monitored current load.

3. The panel of claim 2, wherein the AC power is 110 or 220 VAC and the DC power is 12 or 24 VDC.

4. The panel of claim 2, wherein the power supplies comprise NEC (National Electrical Code) Class 2 power supplies.

5. The panel of claim 2, comprising a communication module coupled to the processor.

6. The panel of claim 5, wherein the communications module is an IP module.

7. The panel of claim 5, wherein the processor is configured to reduce DC power outputted by the panel in response to communications received by the communications module.

8. The panel of claim 7, wherein the communications module is configured to communicate with networked devices coupled to the DC port.

9. The panel of claim 2, wherein the AC port is configured for being connected to an AC power source.

10. The panel of claim 9, wherein the DC port is configured for being connected to one or more DC loads.

11. The panel of claim 10, comprising an AC circuit breaker disposed electrically between the AC port and circuit board.

12. The panel of claim 11, wherein the DC port comprises a terminal strip configured for connection to a plurality of DC loads.

13. The panel of claim 12, wherein the processor is configured to limit the output to each terminal connection to less than a predetermined power level.

14. The panel of claim 13, wherein the processor is configured to limit the output to each terminal connection to 100 watts or less.

15. The panel of claim 14, wherein the processor is configured to deactivate individual ones of the power supplies upon detection of power output outside of a predetermined range.

16. The panel of claim 15, wherein the processor is configured to actuate an alarm signal in the event of said power output outside of a predetermined range.

17. The panel of claim 16, wherein said alarm comprises cycling power output from the panel.

18. The panel of claim 2, comprising a visual indicator of status of each of the power supplies.

19. The panel of claim 2, wherein the power supplies are configured for being unplugged from the AC and DC connector arrays.

20. The panel of claim 2, further comprising DC power contacts coupled to the DC connector array, the DC power contacts configured to receive DC power from local sources.

21. The panel of claim 20, wherein the DC power contacts are coupled to the DC connector array via one or more DC circuit breakers.

22. The panel of claim 20, wherein the DC power contacts are configured for being coupled to a local power source selected from the group consisting of solar, wind, fuel cell, battery, and combinations thereof.

23. The panel of claim 21, wherein the processor is configured to turn off the power supplies as power from local power sources are available.

24. The panel of claim 23, comprising one or more DC to AC inverters configured to generate AC power when sufficient local power sources are available.

25. A method of distributing DC power to a premises, the method comprising:
(a) installing the panel of claim 2;
(b) coupling the AC port to a national electrical grid; and
(c) coupling the DC port to one or more DC loads, wherein the processor selectively activates and deactivates various power supplies in response to the monitored current load.
